(19) United States
(12) Patent Application Publication
(10) Pub. No.: US 2017/0175780 A1
(43) Pub. Date: Jun. 22, 2017

(54) Safety Valve For The Hydraulic Hopper Lifting System Of Compactor Trucks

(71) Applicant: Moisés Castro Salinas, Coacalco de Berriozabal (MX)

(72) Inventors: Moisés Castro Salinas, Coacalco de Berriozabal (MX); Fabián Moisés Castro Vargas, Coacalco de Berriozabal (MX); Cuahutémoc Castro Salinas, Coacalco de Berriozabal (MX)

(73) Assignee: Moisés Castro Salinas, Coacalco De Berriozabal (MX)

(21) Appl. No.: 15/310,934

(22) PCT Filed: May 14, 2015
(86) PCT No.: PCT/MX2015/000074

§ 371 Date: Feb. 15, 2017

(30) Foreign Application Priority Data
May 14, 2014 (MX) MX/U/2014/000203

(51) Int. Cl. F15B 13/01; F16K 17/02; F15B 20/00

(52) U.S. Cl. CPC F15B 13/01; F15B 20/005; F16K 17/02; B65F 3/26

(57) ABSTRACT

This invention relates to a safety valve for preventing the piston of hydraulic cylinders from falling, by retraction, as a result of pressure drops in the hopper lifting system of a compactor truck.

### FIELD OF INVENTION

The present invention relates to useful media or elements for the assurance and protection of compactor vehicle hopper function. In particular, this invention relates to a safety valve for the hydraulic hopper lifting system of compactor trucks.

### BACKGROUND OF THE INVENTION

Most mobile compaction systems for waste management have a hopper system in the rear of compactor units. Said hoppers are entry systems powered by hydraulic cylinders that consist of a waste receiving area and a compacting plate series guiding material into the inner cavity of the unit. These hopper systems are only loading mechanisms, so that, the waste unloading from the compaction compartment is carried out lifting the hopper completely with respect to an axis or fulcrum through a hydraulic cylinder series, in that way such movement allows to unlock the rare side of the compaction compartment and by displacing the compacting plate the waste is expeled from the box.

However, these types of systems have serious security problems because hydraulic cylinders can have pressure losses due to system failures, such as the rupture of hoses, loss of fluid through loose joints, pressure pump failures, power supply failures, among others. Of all the possible failures, the most common is the loss of pressure as a result of hydraulic system hoses perforation. Due to the heavy weight of the hopper, this leads to inevitable collapse of the hydraulic cylinder pistons, causing the uncontrollable fall of the whole system. When this happens, compactor truck operators are at risk of serious injury and even death by crushing.

In view of this problem, there is a necessity to seek out systems that ensure operator's safety avoiding the abrupt collapse of hydraulic cylinders due to pressure losses in the system.

### SUMMARY OF THE INVENTION

Due to the aforementioned problems, an objective of the present invention is to provide a safety valve for lifting the compactor truck hopper, avoiding the fall of the hopper from the open position.

An additional objective of the present invention is to provide a safety valve for compactor truck hoppers for avoiding pressure loss from fluid leaks in hydraulic cylinders responsible of lifting the hopper.

### BRIEF DESCRIPTION OF THE FIGURES

FIG. 1 is a view of the safety valve of compactor truck hoppers and its location in the system.

FIG. 2 is a side view of the compactor truck hopper, where the disposition of the safety valve for compactor truck hopper is appreciated with the hopper in a closed position.

FIG. 3 is a side view of the compactor truck hopper, where the disposition of the safety valve for compactor truck hopper is appreciated with the hopper in an opened position.

### DETAILED DESCRIPTION OF THE INVENTION

The present invention is described in relation to the accompanying figures.

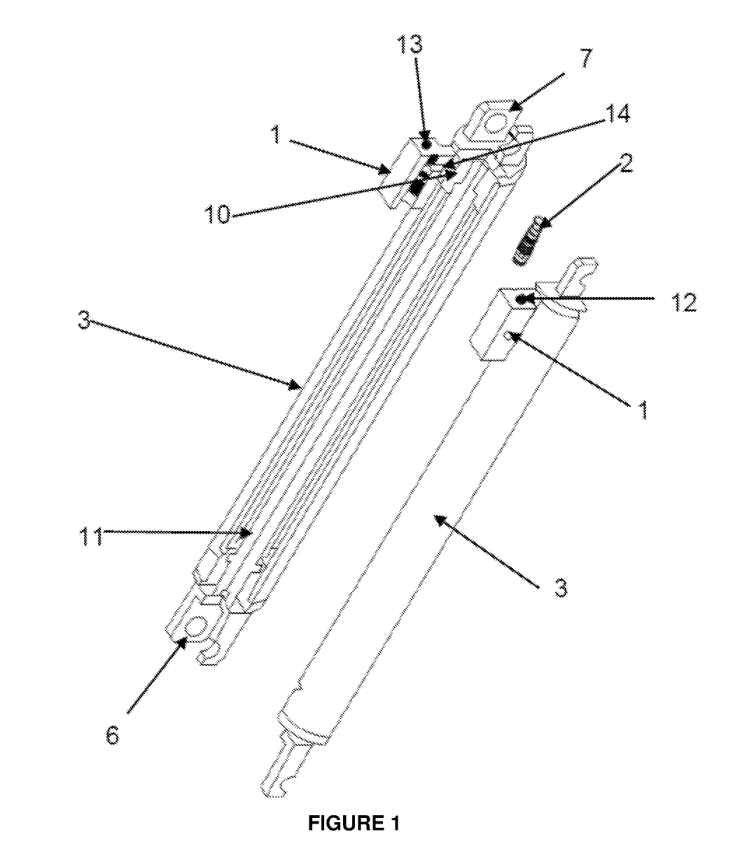

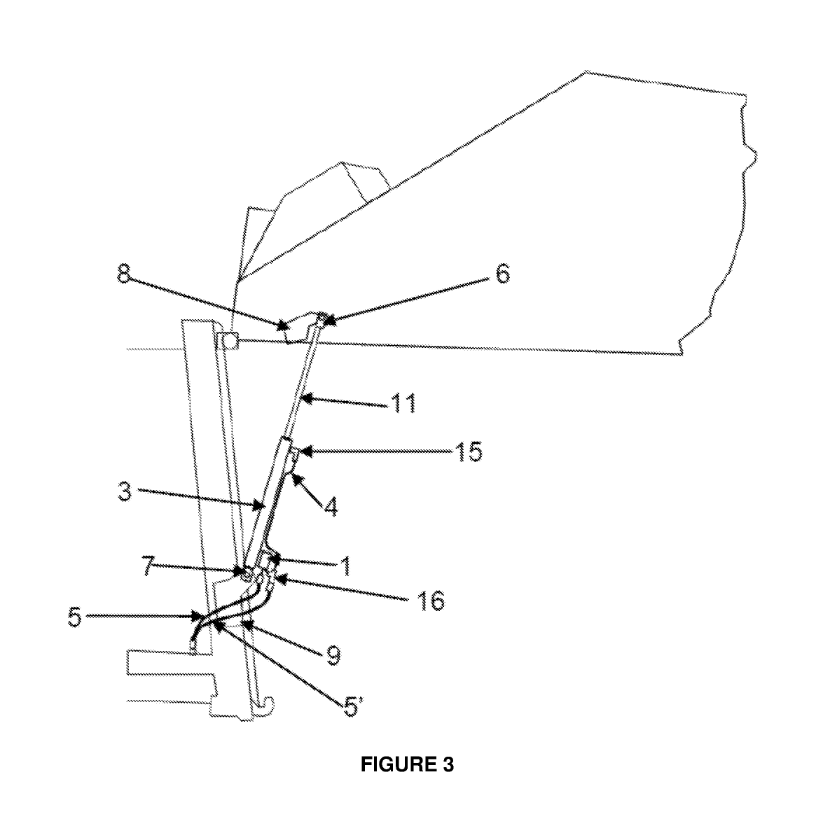

As is appreciated in FIG. 1, the safety valve of the present invention is comprised of a valve body (1) integrated to the hydraulic cylinder (3), with two inlets (12) and (13); a rigid tube (4) and a first and a second hoses for hydraulic fluid (5) and (5′) respectively. The valve body (1) has the function of distributing the supply of hydraulic fluid to the bottom of the hydraulic cylinder (3) having a first fluid inlet (14) and is fixed by the anchor points (6) and (7) to the hopper (8) and the compactor truck box (9) respectively, so that an increase in the internal pressure in the first valve body inlet (12) caused by the admission of hydraulic fluid from the first hose (5) increases the retaining cartridge (2) located within the valve body (1), unblocking the fluid path to the first fluid inlet (14) at the bottom of the hydraulic cylinder (3) causing movement of the piston (10), thereby extending the rod (11) to its fully extended position (FIG. 3). Said movement lifts the hopper and unblocks the rare of the compactor truck (9). A drop in pressure from the first hose (5) causes the drop of the retaining cartridge (2), closing the passage to the first fluid inlet (14) of the bottom of hydraulic cylinder (3), blocking all possible movement, which prevents the lowering of the hopper (8), even with the engine off and this allows the compacted material unloading or carry out the maintenance of the hopper (8) safely by operators.

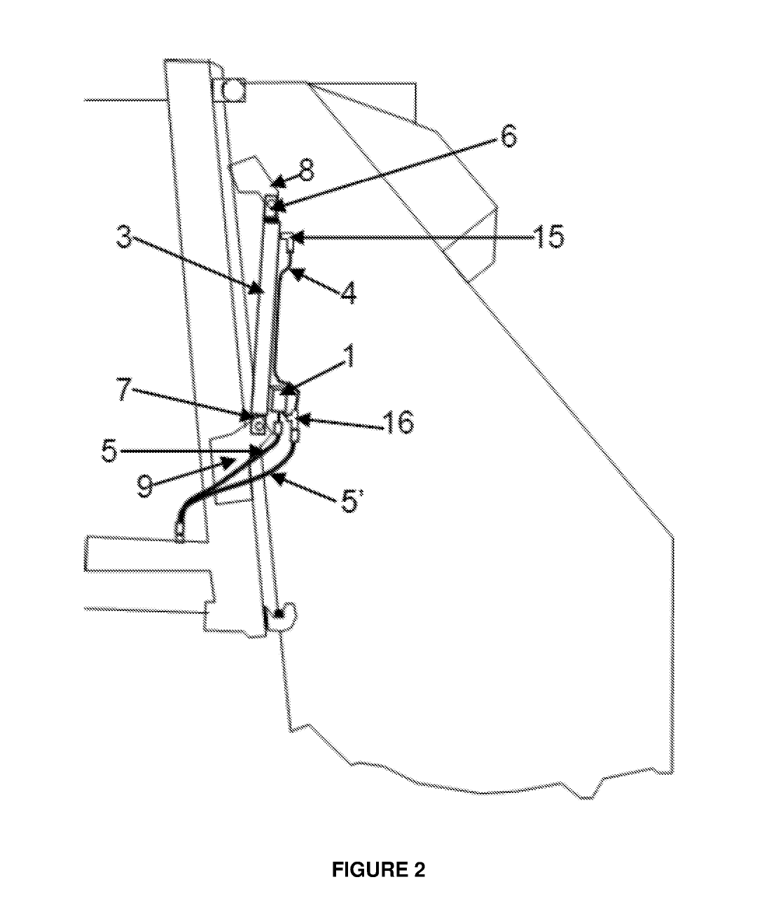

Once the maintenance or unloaded work is finished, the lowering of the hopper is performed by a pressure increase guiding hydraulic fluid through the second hose (5′) to the second inlet of the valve body (13), which lifts the retaining cartridge (2) unblocking the first fluid inlet (14) at the bottom of hydraulic cylinder (3), allowing the exit of hydraulic fluid through the first hose (5) and causing the lower of the piston (10)which retracts the stem (11) and thereby causes the lowered of the hopper (8) to its closed position as shown in FIG. 2). This last movement also requires the entry of hydraulic fluid to the second fluid inlet (15) located at the top of the hydraulic cylinder (3), which is achieved through a T-shaped connection (16) placed between the second hose (5′) and the valve body (1) to provide a connection point for the rigid tube (4), which guides hydraulic fluid coming from the second hose (5′) to the top the hydraulic cylinder (3).

The present invention have been described according to a preferred modality; however, it will be apparent for a skill person in the art that modifications may be made to the invention without turning away from its spirit and scope.

1. A safety valve for a hydraulic hopper lifting system of a compactor truck, comprising a valve body with first and second inlets located in the lower part thereof and disposed on the first hydraulic fluid inlet located in a bottom face of a hydraulic cylinder; a retaining cartridge located inside the valve body; first and second hoses for hydraulic fluid connected to the first and second inlets of the valve body; and a rigid tube connected to the second hydraulic fluid inlet located at the upper part of the hydraulic cylinder and to a T-shaped connector located between the second hose and the second valve body inlet; such that when the hydraulic fluid pressure increases in the first inlet of the valve body, the hydraulic fluid enters through the first hydraulic fluid hose, lifting the retaining cartridge and unblocking the fluid passage to the first hydraulic cylinder inlet, thereby lifting the piston and the stem to move the hopper to an open position, wherein, when the hydraulic fluid pressure decreases in the first hydraulic fluid inlet of the valve body, the retaining cartridge falls, closing the passage of the first hydraulic fluid inlet of the hydraulic cylinder and locking the hopper in the open position, wherein, an increase in pressure due to the inlet of hydraulic fluid in the second inlet of the valve body through the second hose lifts the retaining cartridge, and unblocks the fluid passage from the hydraulic cylinder to the first hydraulic fluid inlet and allows the piston and stem to fall, which occurs through the entry of hydraulic fluid through the second fluid inlet located at the upper part the hydraulic cylinder, supplied via the rigid tube connected to said second hydraulic fluid inlet and to the T-shaped connector located between the second hose and the second inlet of the valve body, thereby lowering the hopper.

2. The safety valve for the hydraulic hopper lifting system for compactor trucks according to claim 1, wherein the hydraulic cylinder remains entirely extended due to the block of the lower fluid inlet, avoiding the uncontrolled hopper fall even in system pressure loss conditions.

3. The safety valve for the hydraulic hopper lifting system for compactor trucks according to claim 1, wherein the valve is located in each of the two hydraulic cylinders for the hopper lifting system, one valve for each hydraulic cylinder.

4. The safety valve for the hydraulic hopper lifting system for compactor trucks according to claim 1, wherein the valve is directly located over the lower fluid inlet of the hydraulic cylinder.
